(19) United States
(12) Patent Application Publication
(10) Pub. No.: US 2002/0194740 A1
(43) Pub. Date: Dec. 26, 2002

(54) Pineapple knife

(76) Inventor: Paul Lee, Signal Hill, CA (US)

Correspondence Address: Paul Lee, 1841 Molino Ave Apt#3, Signal Hill, CA, 90804, US

(21) Appl. No.: 09/884,972

(22) Filed: Jun. 21, 2001

(51) Int. Cl. B26B 3/00; B26B 9/00

(52) U.S. Cl. 30/315; 30/353

(57) ABSTRACT

when preparing pineapple for consumption this knife makes it easier and faster to remove the eyes of pineapples, and save good pineapple meat that is closer to the skin.

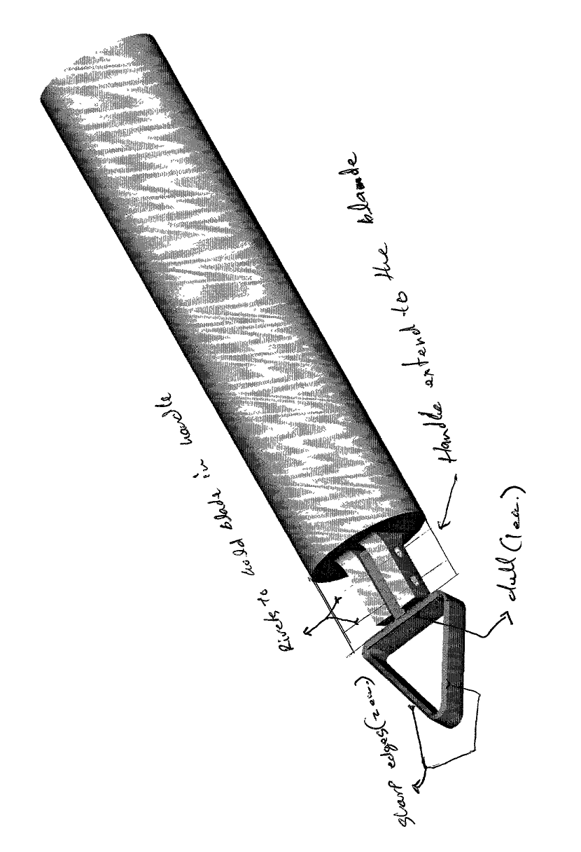

### CROSS REFERENCE TO RELATED APPLICATIONS

Not Applicable

### STATEMENT REGARDING FEDERALLY SPONSORED RESEARCH OR DEVELOPMENT

Not Applicable

### REFERENCE TO SEQUENCE LISTING, A TABLE, OR A COMPUTER PROGRAM LISTING APPENDIX

Not Applicable

### BACKGROUND OF THE INVENTION

Not Applicable

### BRIEF SUMMARY OF THE INVENTION

This knife is use to remove the eyes of Pineapples.

### BRIEF DESCRIPTION OF THE DRAWING

The drawing shows a triangular shape, measured half of an inch in all sides and half an inch in all width(s) and has a handle in the middle of one side.

### DETAILED DESCRIPTION OF THE INVENTION:

A piece of stainless steel having half of an inch in width and 16^{th} of an inch in thickness is bent into a triangular shape measuring half an inch in all sides. One of the three sides has a handle in the middle, and the other two sides are sharpening on the same side of edges to cut the pineapple. All three angles have a small radius from forming. The knife cuts the eyes of the pineapple in a spiral form from top to bottom because pineapple eyes arrange in a spiral row.

1. What I claim as my invention is the triangular shape of the knife that is hollow on the inside.
